(19) United States
(12) Patent Application Publication
(10) Pub. No.: US 2023/0196270 A1
(43) Pub. Date: Jun. 22, 2023

(54) METHODS AND SYSTEMS FOR IMPROVED ADDRESS ENTRY INTERFACE

(71) Applicant: Shopify Inc., Ottawa (CA)

(72) Inventors: Diego Pires PLENTZ, Toronto (CA); Nicholas Andrew MONTGOMERY, Toronto (CA)

(73) Assignee: Shopify Inc., Ottawa (CA)

(21) Appl. No.: 17/557,101

(22) Filed: Dec. 21, 2021

(51) Int. Cl. G06Q 10/08; G06F 16/29; G06F 3/0484

(52) U.S. Cl. CPC G06Q 10/08355; G06F 16/29; G06F 3/0484

(57) ABSTRACT

Methods and systems for obtaining address data, generating improved deliverable addresses, and generating an improved database of address information. Address data input to a graphical user interface (GUI) may be used to identify a location represented by an address entry in an address database. If the address entry is associated with supplemental address information, the GUI is modified to include a supplemental address information field to obtain additional address data, which is then combined with the address data to produce a complete deliverable address output. A history of delivery notifications, whether failures or successes, together with address data used in attempting the deliveries may be stored and used in determining whether to associate a location with supplemental address information, and to identify type or class of supplemental address information to associate with the location.

### TECHNICAL FIELD

The present disclosure relates to computer-implemented user interfaces, and more particularly to, address entry systems and databases and interfaces for obtaining accurate address data.

### BACKGROUND

Online systems commonly require users to enter an address, whether for payment processing, delivery, identification, or for other reasons. In online commerce in particular, address entry is of particular importance for ensuring successful delivery of goods. In order to ensure accurate address entry, existing platforms rely on a database of addresses to compare to entered data in order to determine whether the address exists and is in a valid form. The database may be from a government source, such as a postal database or municipal database, or may be from a third party provider, like Google™.

Some regions have well-defined and structured schemas for addresses, such that any compliant address must have certain clearly defined features to be valid. Other regions may have poorly defined schemas with wide variations. Many fast-growing areas have municipal locations that have very new addresses or informal addresses that have not yet been recorded in a municipal or other official database. Some databases may only be updated periodically, such as every 3 or 6 months, meaning that large numbers of new or revised addresses are missing or incorrect. These features make address validation very difficult for a platform that operates in many jurisdictions around the world, such as a multi-merchant e-commerce platform.

It would be advantageous to provide for systems and methods of address entry, validation or refinement that improve the accuracy of address entry.

### BRIEF DESCRIPTION OF THE DRAWINGS

Embodiments will be described, by way of example only, with reference to the accompanying figures wherein:

FIG. 1 is a simplified example system;

FIG. 2 is a high-level schematic diagram of a computing device;

FIG. 3 shows a simplified organization of software components stored in a memory of the computing device of FIG. 2;

FIG. 4 shows one example method of obtaining address data through a graphical user interface;

FIG. 5A to 5E illustrate simplified example graphical user interfaces and modified graphical user interfaces;

FIG. 6 shows one example method of generating an improved address database;

FIG. 7 is a block diagram of an e-commerce platform, in accordance with an example embodiment; and

FIG. 8 is an example of a home page of an administrator, in accordance with an example embodiment.

Like reference numerals are used in the drawings to denote like elements and features.

### DETAILED DESCRIPTION OF EMBODIMENTS

In one aspect, the present application discloses a computer-implemented method of obtaining address data and generating deliverable address data. The method may include receiving address data input via one or more address fields in a graphical user interface; searching a database of address entries, using the address data, to identify a location; determining that the location is associated with supplemental address information; responsive to the determining, causing generation of a modified graphical user interface that displays a supplemental address field that was not displayed in the graphical user interface; receiving additional address information via the supplemental address field; and outputting a complete deliverable address containing at least the address data and the additional address information.

In some implementations, determining includes determining, from the database, that the location is associated with a deliverable address schema, and wherein the deliverable address schema includes the supplemental address information.

In some implementations, searching includes matching at least a portion of the address data to one or more address entries and, based on the address entries, identifying the location.

In some implementations, the location is a multi-unit building, and the supplemental address information includes one or more of a unit number, a mailbox number, a buzzer code, a door code, a locker number, building name, or a floor number. In some other cases, the location is a municipal area that includes multiple buildings, and the supplemental address information includes one or more of directional text, descriptive text, or a map pinpoint.

In some implementations, the method may further include receiving a plurality of delivery notifications from one or more carriers with regard to deliveries to the location; and updating the database to associate the location with the supplemental address information based on the plurality of delivery notification. In some cases, the plurality of delivery notifications include one or more failure notifications and one or more success notifications with regard to deliveries to the location. The method may further include comparing address information associated with success notifications to address information associated with failure notifications to generate a deliverable address format requirement for the location, wherein the deliverable address format includes the supplemental address information, and updating the database to associate the location with the deliverable address format requirement.

In some implementations, the method may further include receiving one or more delivery failure notifications relating to the location; and updating the database based on the delivery failure notifications to associate the location with the supplemental address information. In some cases, the method may further include, in response to the one or more delivery failure notifications, transmitting a delivery failure inquiry to one or more accounts associated with the one or more delivery failure notifications and, in response, receiving feedback data that specifies the supplemental address information.

In some implementations, causing generation of the modified graphical user interface includes sending data to a user device and the user device generates and displays the modified graphical user interface based on the data.

In some implementations, causing generation of the modified graphical user interface includes sending data to a user device and the user device uses the data to modify the graphical user interface displayed on the user device to produce the modified graphical user interface.

In another aspect, the present application discloses a computing device having a processor and memory. The memory may store instructions that, when executed by the processor, cause the processor to carry out one of the methods or processes described herein.

In yet another aspect, a non-transitory, computer readable storage medium is disclosed. The medium may store processor-executable instructions that, when executed, cause one or more processors to carry out the operations of one or more of the methods or processes described herein.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . and . . . ” is intended to cover any one or more of the listed elements, including any one of the listed elements alone, any sub-combination, or all of the elements, without necessarily excluding any additional elements, and without necessarily requiring all of the elements.

In the present application, the term “e-commerce platform” refers broadly to a computerized system (or service, platform, etc.) that facilitates commercial transactions, namely buying and selling activities over a computer network (e.g., Internet). An e-commerce platform may, for example, be a free-standing online store, a social network, a social media platform, and the like. Customers can initiate transactions, and associated payment requests, via an e-commerce platform, and the e-commerce platform may be equipped with transaction/payment processing components or delegate such processing activities to one or more third-party services. An e-commerce platform may be extendible/extensible by connecting one or more additional sales channels representing platforms where products can be sold. In particular, the sales channels may themselves be e-commerce platforms, such as Facebook Shops™, Amazon™, etc. The e-commerce platform may serve one merchant in some implementations. The e-commerce platform may be a multi-merchant platform in other cases, where each merchant is able to use some or all of the available services to configure an online storefront and provide commerce services to customers of the online storefront. A multi-merchant e-commerce platform may operate across a range of geographic regions, and may operate in multiple countries, currencies, and time zones.

An e-commerce platform may provide shipping or delivery services, as will be described further below. In many implementations, the actual shipping or delivery may be carried out by one or more third party carriers that receive instructions and delivery data from the e-commerce platform. Other online systems aside from e-commerce platforms may also involve shipping or delivery services. As an example, some non-profit or government service portals may provide for delivery of documents or other items to a user.

Delivery or shipping of items to a user by an online platform, whether through third party carriers or not, requires the platform to obtain accurate delivery address information. In order to ensure accurate address entry, platforms may rely on a database of addresses to compare to entered data in order to ensure the address exists or that the address conforms to an expected schema. The database may be from a government source, such as a postal database or municipal database, or may be from a third party provider.

Some regions have well-defined and structured schemas for addresses, such that any valid address must be in a certain format to be valid. For example, many North American addresses have at least a street number, a street name, city or town, and state or province. However there are exceptions, particularly in remote rural locations. For postal delivery, a postal code is often required. Other regions may have poorly-defined schemas with wide variations. Some databases may be incomplete.

The term “address” as used herein refers to alphanumeric data that specifies a location. Typical addresses in many countries take the form of a street/building number, street name, and municipality name. The term “postal address” or “municipal address” may refer to an address sufficiently detailed to enable delivery of mail by a postal service. This may include a postal code in some cases. The term “deliverable address” may refer to an address sufficiently detailed to enable delivery of a package or other such item by a carrier service. A deliverable address is not necessarily the same as a postal address. The postal address may require a postal code, whereas the deliverable address may not. The deliverable address may include additional information to enable a carrier to identify the specific unit, person, or location for giving effect to the delivery, whereas a postal address may not. An example of the latter may be the case where a postal authority is able to deposit mail in a mailbox that cannot accept delivered packages.

The term “location” may refer to a building, region, campus, or other locale identified by partial or full address information. A “location” as used herein may include more than one possible address for delivery. For example, a “location” may be a multi-unit building that has a single municipal or postal address, yet contains more than one distinct unit to which deliveries could be made. As another example, a “location” may be an address sufficiently detailed to pinpoint a set of buildings, a campus, a neighbourhood, a general area or tract of land, or some other geographic locale within which there could be multiple “addresses” for delivery.

One of the challenges confronted by online address entry and delivery of materials is that the entered address may not be found in an out-of-date database provided by a third party, so it cannot be validated. Another challenge is that the address schema for a region may be so informal or ill-defined that entered address information may not be meaningfully validated or compared to official address database information. Yet a further challenge is that even where there is a valid postal address database available, the entered address information may match a valid postal address but will be insufficient to successfully complete delivery. A failed delivery may result in wasted resources, delayed fulfillment, and in some cases cancelled sales and/or landfilled undeliverables.

It would be advantageous to provide for a system and method that reduces the likelihood of failed deliveries. To the extent that such a system and method relies on a database of address information, it would further be advantageous to provide for systems and methods of improving the accuracy of the database of address information to produce an improved database. With online platforms that involve delivery, obtaining correct and valid address information is vital to reducing the likelihood of failed delivery. It would further be advantageous to provide for improved online platforms and methods of obtaining address data that result in more accurate delivery addresses and reduce failed deliveries.

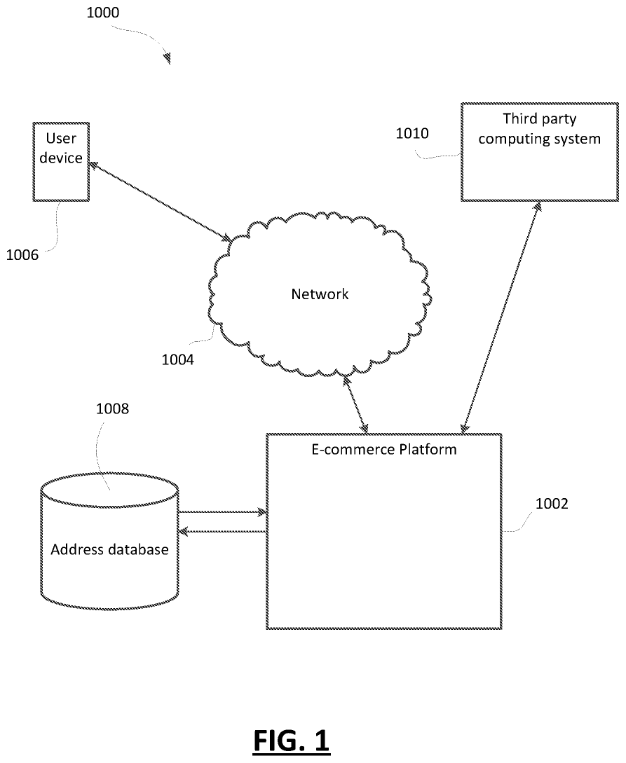

Reference will now be made to FIG. 1, which diagrammatically illustrates a simplified example system 1000 in accordance with an aspect of the present application. The example system 1000 may include an e-commerce platform 1002. The e-commerce platform 1002 may provide for one or more online storefronts browsable by a user computing device 1006 that connects to the e-commerce platform 1002 via one or more computing networks 1004, such as the Internet. The user computing device 1006 may include any suitable computing device with at least a display screen and a user input device, such as a mobile smartphone, tablet, laptop, desktop, or other such devices.

The e-commerce platform 1002 may be coupled to an address database 1008. The address database 1008 may be maintained by the e-commerce platform 1002. Data within the address database 1008 may originally be obtained by the e-commerce platform 1002 from one or more government or third-party sources, but may include additional information or refined information, as will be described below.

The system 100 may further include one or more third party delivery computing systems 1010, such as couriers, postal systems, or other third-party computing systems configured to receive delivery instructions and address data. In some cases, the e-commerce platform 1002 includes a fulfilment center at which goods are packaged, labelled, and either sent to, or picked up by, a delivery service. The delivery service may include the computing system 1010 may then provide the e-commerce platform 1002 with one or more notifications relating to the status of the delivery.

When the user computing device 1006 browses a merchant's available offerings on the e-commerce platform 1002, selects one or more goods, and enters a checkout phase to complete payment, the e-commerce platform 1002 causes the user computing device 1006 to display a graphical user interface (GUI) configured to obtain payment and delivery information. In the context of obtaining delivery information, the GUI map includes fields and prompts to obtain delivery address data. The user computing device 1006 receives input address data that it passes to the e-commerce platform 1002. The input data may be input via one or more designated fields in the GUI, such as for receiving a country selection, municipality, street address, etc. In some cases, the user computing device 1006 may be operated by a customer making an order. In some contexts, the user computing device 1006 may be operated by a merchant/employee entering data on behalf of a customer, or completing a fulfilment stage at a later time.

The e-commerce platform 1002 may, as address data input is received, attempt to match the address data to one or more addresses in the address database 1008. Based on searching the address database 1008, the e-commerce platform 1002 may determine that the address data input relates to a certain location identified in the address database 1008. The database 1008 may further indicate that the location is associated with supplemental address information. That is, to improve or obtain deliverability, the address data should be supplemented with some additional data. In some cases, this may be a unit number. In some cases, the supplemental information may be a unit number, a mailbox number, a buzzer code, a door code, a locker number, building name, or a floor number. Such may be the case where the location is a multi-unit or multi-tenant building. In some cases, the location is a municipal area, such as a subdivision, neighbourhood, campus, intersection, etc., and the supplemental information may be direction text, descriptive text, or a map pinpoint or coordinates, as examples.

The e-commerce platform 1002, having determined from the address database 1008 that the location indicated by the address data input should be supplemented with additional information, then causes the user computing device 1006 to display a modified graphical user interface that includes a field or other input element soliciting the supplemental address information. The modified GUI may include one or more informational prompts to indicate the type or form of supplemental information sought. The e-commerce platform 1002 may determine the nature of the field or other input element from the type or category of supplemental address information indicated by the address database 1008 and may cause the user computing device 1006 to generate the modified graphical user interface such that it displays the correct field or other input element for receiving the supplemental address information. It will be understood that the field or other element for receiving the supplemental address information is one that does not appear in the original GUI displayed on the user computing device 1006 to receive the address data.

In some cases, the modified graphical user interface is a new GUI containing the address fields of the previous GUI but supplemented with the new field or input element. In some cases, the modified graphical user interface is a pop-up window or the like, overlaid atop the original GUI. Other possible implementations will be understood in light of the illustrative examples provided below.

The e-commerce platform 1002 may then receive additional address information via the modified GUI that it may combine with the address data to produce or output a complete deliverable address. The complete deliverable address may then be printed on a shipping label, transmitted to a fulfillment center for printing on a shipping label, transmitted to a delivery service system, or otherwise acted upon.

In one aspect, the e-commerce platform 1002 may be configured to refine the address database 1008 using feedback from deliveries to the location. For instance, when the platform 1002 generates a deliverable address in association with a delivery, it stores data associating that delivery order with the address in the form it was output.

Subsequently, the platform 1002 may receive a delivery notification. The delivery notification may be from a third party delivery computing system 1010, in some cases. For instance, a third party carrier may configure their computing system 1010 to provide delivery notifications to the platform 1002. In some cases, the computing system 1010 may provide an API or other access capability to enable the platform 1002 to poll the computing system 1010 for status information regarding the delivery order. The delivery notification from the computing system 1010 may provide a status or status code. The status code may indicate whether the delivery is in progress, completed, or failed, for example. In some cases, the delivery notification may include a reason for failure. The reason may be a narrative text entry describing the reason for failure or may be a code or indicator selected from a preconfigured set of codes or indicators corresponding to a predetermined set of reasons for failure.

In some cases, the delivery notification may be received from the merchant account or from the customer account. In some cases, the delivery notification may be based on a delivery success query sent by the platform 1002 to the third party computing system 1010, the merchant account, and/or the customer account. In some cases, receipt of a delivery notification from the third party computing system 1010 may trigger the sending of a delivery failure query to the merchant account and/or the customer account, providing any reasons for non-delivery and soliciting data regarding identified address errors in the complete deliverable address used for the delivery.

Irrespective of the source, the delivery notification provides at least a binary indication of success or failure with regard to the delivery. The platform 1002 may then retrieve the corresponding address information associated with the delivery order and may update its historical data regarding deliverability of that address. The deliverability may be associated with the specific address, or more broadly with a location within which the address is located. For example, the location may be a multi-tenant building and the specific address may be a unit within that building. The location may be neighbourhood and the specific address may be a physical building or dwelling within the neighbourhood.

As the platform 1002 receives delivery notifications with regard to addresses associated with a location, it may update its determination as to whether supplemental address information is needed for that location and, if so, a type or category of supplemental address information. For instance, if a delivery notification indicates a failure the platform 1002 may compare the contents of the address used in the failed delivery with addresses used for that location that had successful deliveries to identify any differences in address content that may signal that missing data caused the failure. Similarly, the platform 1002 may compare the contents of the address used in a failed delivery with addresses used for that location that also had failed deliveries to identify any similarities in address form or content that may signal why the delivery failed. By comparing the form and/or contents of successful and failed deliveries for a location, the platform 1002 may determine a probability that certain data is required and/or that certain data is correlated to delivery success for the location.

Examples may include inclusion of a unit number, inclusion of a buzzer code or other such access control information, inclusion of a building name, inclusion of a locker number, inclusion of a floor number, inclusion of a descriptive narrative, inclusion of a map pinpoint, etc.

Once the platform 1002 determines with more than a threshold level of probability/confidence, that supplemental address information is required for successful delivery to a location, the address database 1008 is updated to associate the supplemental address information with the location, such that in the future when an order is placed for delivery to that location the platform 1002 cause a user device to display a GUI that solicits input of the supplemental address information. The threshold level of probability may be 70%, 80%, 90%, 95%, 99%, or any other suitable level depending on the implementation. The calculated probability may impact whether the platform 1002 designates the supplemental address information as optional or required. The GUI displayed on the user device 1006 may indicate whether the information is optional or required. If required information is not input into the supplemental address information field, or is an incorrect form, the platform 1002 may block completion of the checkout until the information is provided. Causing the user device 1006 to display a modified GUI may include sending data to cause generation and display of the modified GUI in place of the original GUI, or may include sending data to cause an update or revision to the original GUI and results in the modified GUI.

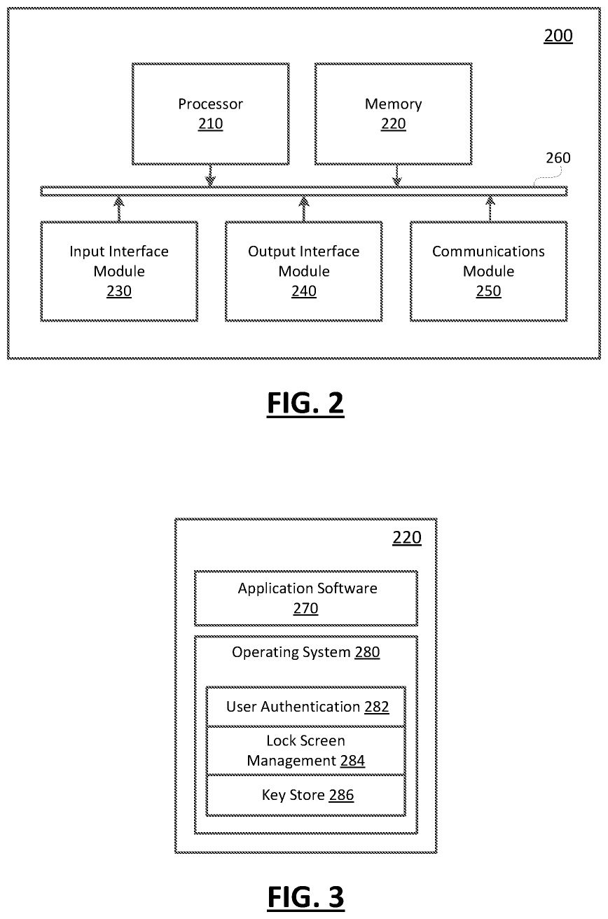

The e-commerce platform 1002 may be implemented using one or more computing devices. FIG. 2 is a high-level diagram of an example computing device 200. The example computing device 200 includes a variety of modules. For example, the example computing device 200 may include a processor 210, a memory 220, an input interface module 230, an output interface module 240, and a communications module 250. As illustrated, the foregoing example modules of the example computing device 200 are in communication over a bus 260.

The processor 210 is a hardware processor. The processor 210 may, for example, be one or more ARM, Intel x86, PowerPC processors, or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 200.

The input interface module 230 allows the example computing device 200 to receive input signals. Input signals may, for example, correspond to input received from a user. The input interface module 230 may serve to interconnect the example computing device 200 with one or more input devices. Input signals may be received from input devices by the input interface module 230. Input devices may, for example, include one or more of a touchscreen input, keyboard, trackball or the like. In some embodiments, all or a portion of the input interface module 230 may be integrated with an input device. For example, the input interface module 230 may be integrated with one of the aforementioned example input devices.

The output interface module 240 allows the example computing device 200 to provide output signals. Some output signals may, for example, allow provision of output to a user. The output interface module 240 may serve to interconnect the example computing device 200 with one or more output devices. Output signals may be sent to output devices by output interface module 240. Output devices may include, for example, a display screen such as, for example, a liquid crystal display (LCD), a touchscreen display. Additionally, or alternatively, output devices may include devices other than screens such as, for example, a speaker, indicator lamps (such as, for example, light-emitting diodes (LEDs)), and printers. In some embodiments, all or a portion of the output interface module 240 may be integrated with an output device. For example, the output interface module 240 may be integrated with one of the aforementioned example output devices.

The communications module 250 allows the example computing device 200 to communicate with other electronic devices and/or various communications networks. For example, the communications module 250 may allow the example computing device 200 to send or receive communications signals. Communications signals may be sent or received according to one or more protocols or according to one or more standards. For example, the communications module 250 may allow the example computing device 200 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 250 may allow the example computing device 200 to communicate using near-field communication (NFC), via Wi-Fi™, using Bluetooth™ or via some combination of one or more networks or protocols. Contactless payments may be made using NFC. In some embodiments, all or a portion of the communications module 250 may be integrated into a component of the example computing device 200. For example, the communications module may be integrated into a communications chipset.

Software comprising instructions is executed by the processor 210 from a computer-readable medium. For example, software may be loaded into random-access memory from persistent storage of memory 220. Additionally, or alternatively, instructions may be executed by the processor 210 directly from read-only memory of the memory 220.

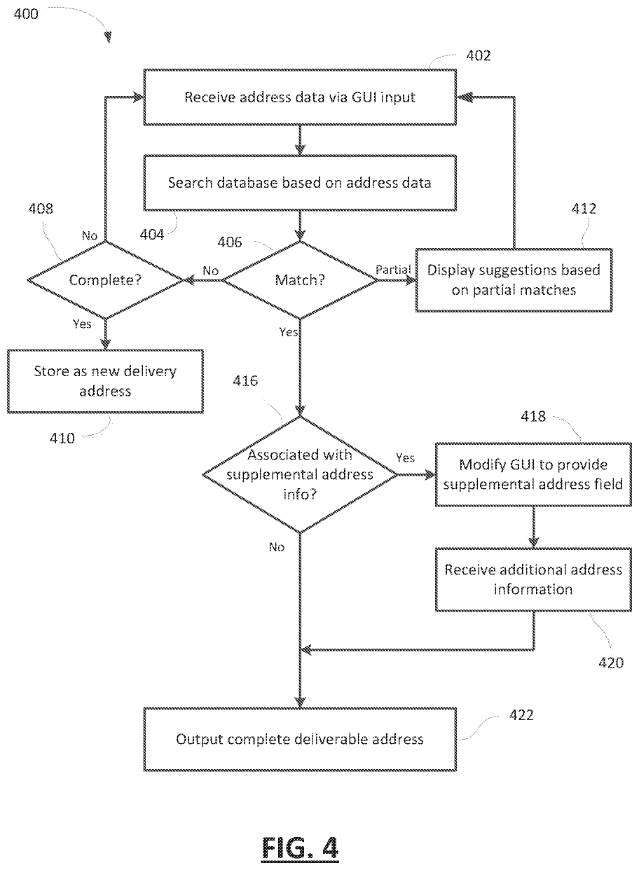

FIG. 3 depicts a simplified organization of software components stored in memory 220 of the example computing device 200. As illustrated, these software components include, at least, application software 270 and an operating system 280.

The application software 270 adapts the example computing device 200, in combination with the operating system 280, to operate as a device performing a particular function. While a single application software 270 is illustrated in FIG. 3, in operation, the memory 220 may include more than one application software and different application software may perform different operations.

The operating system 280 is software. The operating system 280 allows the application software 270 to access the processor 210, the memory 220, the input interface module 230, the output interface module 240 and the communications module 250. The operating system 280 may, for example, be iOS™, Android™, Linux™, Microsoft Windows™ or the like.

The operating system 280 provides various system services for the example computing device 200. User authentication services 282 includes a suite of services relating to credential enrollments and authentication of device users. For example, user authentication services 282 may include initial enrollment of credentials (e.g., PIN, pattern, password, or the like), credentials management, and processing of authentication tokens. Lock screen management services 284 relate to enabling, disabling, and modifying lock screens on the example computing device 200, and may include graphical user interface (GUI) control, display management, user input processing, and device unlock support.

One or more of the computing devices 200 may be used to implement the e-commerce platform 1002 (FIG. 1) in some examples. The user device 1006 (FIG. 1) may be implemented by the computing device 200 in some cases.

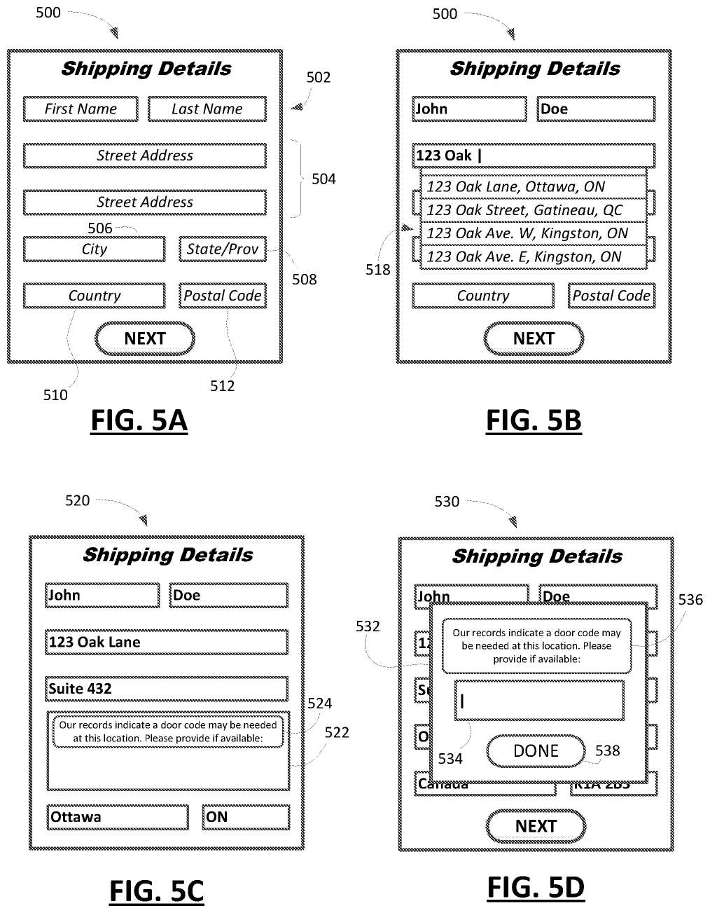

Reference is now made to FIG. 4, which shows, in flowchart form, one example method 400 of obtaining address data through a graphical user interface. The method 400 may be implemented by an e-commerce platform and, in particular, may be implemented by way of suitably-programmed software instructions stored in memory on a computing device which, when executed by one or more processors of the computing device, cause the computing device to carry out the described operations.

In this example, the method 400 may relate to a checkout process on an e-commerce platform. The checkout process may relate to the purchase of one or more goods from an online merchant via the platform. The method 400 may be used by the platform to obtain delivery address information relating to the purchase, so as to enable fulfilment through shipping or delivery of the goods to the provided address. The method 400 includes receiving address data input via a graphical user interface displayed on a user device, as indicated by operation 402. The user device may relay the address data to the e-commerce platform as it is input into the GUI, i.e. character by character. In some cases, the user device may relay the address data to the e-commerce platform once input to a field is completed, such as through detecting a “tab”, “go” or “return” command or a change in cursor focus from the field to another field.

The e-commerce platform searches the address database in operation 404 based on the address data received from the user device in operation 402. In some cases the searching may only occur once a minimum number of characters has been input into the field. In a text field, this may be two, three, four or more. Some fields may not be free form, i.e. they may be picklists of possible address entries, such as country, or province or state, for example. The input address data may include data in multiple fields.

The platform assesses whether the input address data matches one or more address entries in the address database in operation 406. If there is no matching entry to the data input into the GUI, then the platform determines whether the input address information is complete or not. This determination may be based on whether the GUI has received selection of a graphical element indicating that the address entry is completed. This may be a “DONE”, “CONTINUE” or “NEXT” button or the like. The platform may assess whether any required fields are incomplete before determining that the address entry is complete in operation 408. If incomplete, the method 400 continues in operation 402 to receive additional or corrected address data. The platform may cause various warnings or other prompts to be output by the GUI to signal that there is no matching address in the database in case the user wishes to double-check and correct the entered address. Confirmation to proceed with the unmatched address may be required to move to the next stage of a checkout process.

If the address is determined to be complete, then in operation 410 the platform may store the newly-entered address in memory as a new address. In some cases, this may include storing the new address in the database. In some cases, this may include storing the address in memory as a new address, but not updating the address database. Updates to the address database may occur later dependent upon the platform determining that the new address is sufficiently complete and/or that the new address is accurate. Determining that the new address is accurate may be dependent upon determining that one or more deliveries to the new address have been completed successfully. If so, then the address database may be updated with the new address once a threshold confidence score is reached regarding its accuracy.

If a partial match to a database address is found in operation 406, then in operation 412 one or more suggested addresses from the database may be displayed on the GUI for optional selection. Selection of one of the suggested addresses may complete the address entry by selecting as the entered data the address information from the database.

If a complete match is identified in operation 406, the platform may identify whether that location is associated with supplemental information. That is, when the platform determines that the entered address information matches a location in the address database (or when one of the suggested addresses is selected), the platform assesses from the database whether the location is associated with supplemental address information. The association may be indicated by a flag, code, or other signal stored in the address entry in the database. The address entry may indicate type or class of supplemental address information associated with the location. In some cases, the address entry may include a suitable range or prescribed format for the supplemental address information.

If the address entry in the database does not have associated supplemental address information, then in operation 422 the platform utilizes the address entry as the delivery address. This may include outputting the address data as the complete deliverable address. This may include storing the address data within the order record, transmitting the address data to a fulfillment center or a third party computing system associated with fulfillment and/or shipping, printing the address on a shipping label, or other such forms of output to facilitate delivery to the address.

If, however, the address entry in the database indicates that supplemental address information is associated with the location, then in operation 418 the platform causes the user device to display a modified GUI that includes a supplemental address field that was not displayed in the original address entry GUI on the user device. This may include modifying the original GUI to add a field, which may include rearranging other fields. This may include generating a pop-up window or the like within which the supplemental address field is displayed. The modified GUI may further include a text prompt or other guidance signalling the nature of the supplemental address information. The text prompt or other guidance may be based on the address entry in the database and any type or class codes or other data signalling the nature of the supplemental address information sought.

The supplemental address field may be an optional field in some implementations. The address entry may indicate whether the information is required or not. The platform may determine whether the information is required or not based on its calculation of a probability that the information is required for successful delivery. As described above, this calculation may be based on a history of delivery results for deliveries to the location and a comparison of the addresses used in attempting those deliveries. The stronger the correlation between certain missing information and failed delivery, the higher the probability that the information is needed to generate a deliverable address for that location. With a sufficiently high probability, e.g. over 98%, the platform may designate the supplemental address information as a required field in association with the location.

In operation 420 the platform receives additional address information via the supplemental address field and combines the address data with the additional address information to output the complete deliverable address in operation 422. As noted above, this may include storing the address data within the order record, transmitting the address data to a fulfilment center or a third party computing system associated with fulfilment and/or shipping, printing the address on a shipping label, or other such forms of output to facilitate delivery to the address.

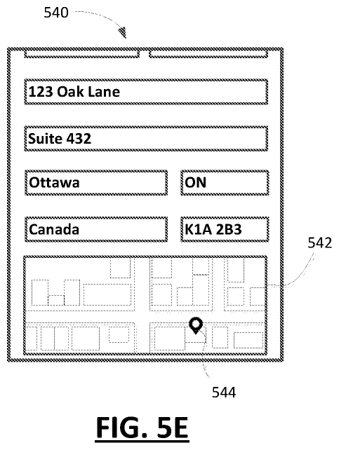

Reference will now be made to FIG. 5A, which illustrates a simplified example of an address input GUI 500. The GUI 500 may be displayed on a client device. In some cases, the GUI 500 may be generated by a commerce application operating on the client device and providing an interface for browsing and purchasing goods from the e-commerce platform, or from a particular merchant on the e-commerce platform. In some cases, the GUI 500 may be generated by a social media application or the like that provides for a commerce interface to enable online purchasing through the social media application. In some cases, the GUI 500 may be generated by a web browser based on web pages obtained from the e-commerce platform. Other possibilities will be appreciated by those ordinarily skilled in the art.

In this simplified example, the client device has entered a checkout phase with regard to a purchase. After confirming cart contents and/or adjusting quantities, the checkout phase may include obtaining address information for delivery of the purchased item(s). The GUI 500 relates to the obtaining of address information for delivery. In this regard, the GUI 500 includes various fields for receiving address information, such as name fields 502, one or more street address fields 504, a municipality field 506, a state or province field 508 (which may be referred to as a “zone” in some systems), a country field 510, and a postal code field 512. In some implementations the country field 510 and other fields may be prepopulated based on settings in the browser or application, based on an IP address, based on GPS data from the user device, or other data indicating the location of the user device. In some cases, the address information may be wholly or partly prepopulated based on previous purchases using the application or browser, or based on user account settings or preferences. Even if fields are not prepopulated, the GUI 500 may be generated partly based on a country or region detected based on IP address, GPS data, or other settings or data. The country or region detected may determine the fields displayed in the initial GUI 500 display, such as whether the state or province field 508 or the postal code field 512 is included in some cases.

In this example, some or all of the fields may not be prepopulated and the user may begin entering or editing address information within the fields. As shown in FIG. 5B, as characters are entered into the street address field 504 the platform may search the address database for possible matching locations. The searching may be based on location data associated with the user device, such that possible matches are ranked based on proximity to the user device. The platform may relay possible matches to the user device as suggested locations, which may then be displayed on the GUI 500 for possible selection.

Irrespective of whether a suggested address is selected or whether an address is entered manually, the platform may then determine whether the entered data matches an address entry in the database. In the case of a selected suggestion, this would necessarily be the case.

In some cases, a “match” to an address in the database means that all the data entered matches a single address entry in the database, although the single address entry may include additional data not found in the entered data. For example, a street address, city and country/territory/region may match a single address entry in the database, but the address entry in the database may include additional information, such as a postal code or state/province. In some cases, a “match” to an address in the database means that the data entered matches all the data found in a single address entry in the database, although the data entered may include additional data. For instance, the data entered may include a building name or a suite number, whereas the address entry in the database may not contain a building name or suite number.

If a “match” is identified, then the platform determines whether the address entry in the database indicates that supplemental address information is associated with the location. If so, then it causes the user device to display a modified GUI to solicit input of the supplemental address information. FIG. 5C shows one simplified example of a modified GUI 520 in which a supplemental address information field 522 appears. In this example, the original GUI 500 (FIG. 5A) is modified to insert the supplemental address information field 522. The modified GUI 520 may further include text guidance 524 indicating the purpose or intended contents of the supplemental address information field 522. In some cases, the text guidance 524 may indicate whether the supplemental address information field 522 is optional or required. In some cases, the text guidance 524 suggests the class or type of supplemental address information that may improve deliverability. As examples, the guidance may be “Unit number”, or “Floor number”, or “Our records indicate a buzzer code may be needed”, or “If available, please provide the door code”, or “Prior deliveries to this area needed a building description. Please provide below.” The user device may then, via the supplemental address information field 522, receive additional address information which it then sends to the platform for combination with the address data previously entered.

It will be noted that in this simplified example, the modified GUI 520 includes all the fields of the original GUI 500, but rearranged to accommodate insertion of the supplemental address information field 522 and the text guidance 524. In another example, as illustrated in FIG. 5D, a modified GUI 530 may be implemented by way of a pop-up window 532, or overlay, or similar graphical display, which contains a supplemental address information field 534 and text guidance 536. The pop-up window 530 may further include a next or done button 538 to indicate that entry of the additional address information, if any, is complete.

In another example, as shown in FIG. 5E, a modified GUI 540 may be generated and displayed that incorporates a map 542. The map 542 may be generated or obtained from a third party geographic information system (GIS) in some cases. The map 542 may be obtained based on the street address entered in the street address field 504, the municipality in the municipality field 506, GPS data from the user device, a region or area associated with an IP address of the user device, or using other such data to obtain initial map coordinates. The map 542 may include graphics indicating streets and buildings based on the GIS data. The map 542 may include a satellite image (or composite image) of the area. The window containing the map 542 may facilitate zoom operations to zoom in or zoom out on the map data.

A pinpoint 544 may be rendered atop the map 542 image. The pinpoint 544 may be moveable within the map 542 or the pinpoint 544 may be in a fixed position within the map window and the map 542 itself may be moveable beneath the pinpoint 544 so as to change the map location indicated by the pinpoint 544.

The modified GUI 540 may be generated by adding the map 542 into the original GUI or by creating a pop-up window or overlay containing the map 542.

Using the map 542, the user device is able to pinpoint a location corresponding to the delivery address by ensuring the pinpoint 544 is positioned at the location of the intended delivery, e.g. the correct house, unit, building, etc. The platform may include the map coordinates corresponding to the pinpoint as part of the complete deliverable address in some implementations. In some cases, an image of the map itself with the pinpoint may be included as part of the complete deliverable address output by the platform.

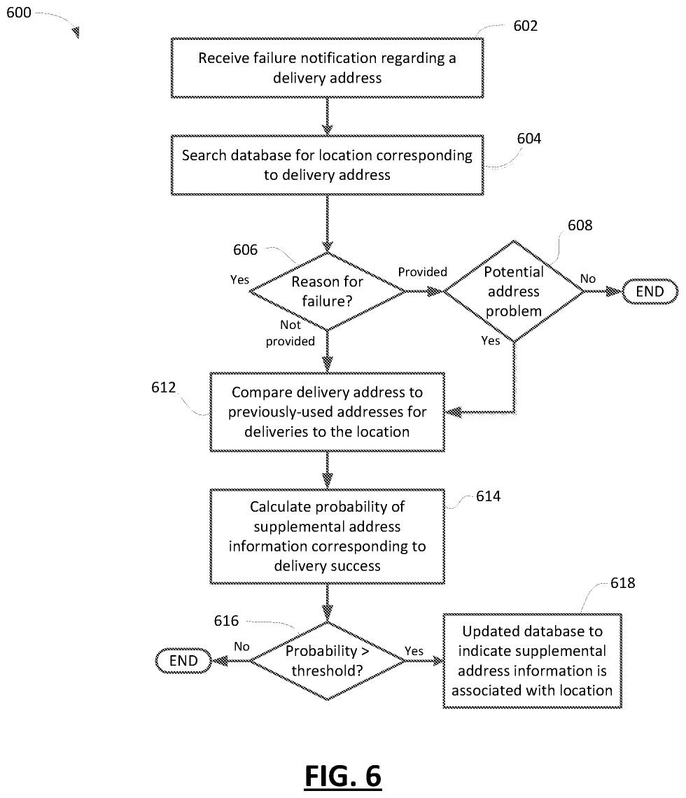

Reference will now be made to FIG. 6, which shows, in flowchart form, one example method 600 of generating an improved address database. The method 600 may be implemented by an e-commerce platform and, in particular, may be implemented by way of suitably-programmed software instructions stored in memory on a computing device which, when executed by one or more processors of the computing device, cause the computing device to carry out the described operations.

The example method 600 includes receiving a delivery status notification in operation 602. In this example, the delivery status notification may be presumed to be a failure notification for the purposes of the following illustration, although a similar process may be carried out with regard to success notifications in some implementations. The failure notification is associated with a delivery order stored on the platform and having an associated delivery address to which the order was to be delivered. The failure notification may be received from a third party carrier or delivery service computing system, such as a courier, postal service, or other transport service.

On receipt of the notification, the platform matches the notification to a delivery order stored on the system and retrieves the order details from memory, including the address information used in attempting delivery, as indicated by operation 604. The failure notification may or may not include a reason for failure. The reason may be a narrative reason specified in text or may be a code or other indicator corresponding to one of a pre-defined set of reasons. The platform may be configured to interpret text reasons to categorize the reason provided into one or more pre-defined reasons. Examples of pre-defined reasons include “address not found”, “wrong address”, “recipient not home—signature required”, “delivery refused”, or similar such reasons.

In some cases on receipt of a failure notification the platform may obtain a delivery failure reason from the carrier, the merchant, or the prospective recipient, e.g. the purchaser, through sending a delivery failure query to an address associated with one or more of those entities and receiving a response selecting a delivery failure reason or declining to provide a delivery failure reason.

In operation 606 the platform assesses whether a reason has been identified, either from the delivery failure notification or from a subsequent query. In some cases, it may be that the platform is unable to determine from the delivery failure notification or any reason data provided, whether the failure is due to a pre-defined category or type of failure reason.

If the reason is identifier, then the platform may determine in operation 608 whether the delivery failure is due to a potential address problem. For example, reasons such as “wrong address” or “address not found” or, more generically, “undeliverable”, may indicate that the problem might possibly be the delivery address. On the other hand, certain reasons, such as “recipient not home—signature required”, are more likely to indicate a problem other than a problem with the delivery address, and thus should not be counted as potential address failures. If the reason does not indicate a potential address problem, then the method 600 may end, but if the reason may be a potential address problem, then the method 600 may continue and may factor the identified “reason” into the later determination of a probability as will be described.

In some instances, failed deliveries are not necessarily reported or flagged as such or as due to an address issue by the carrier. In some cases, the platform may infer an address-dependent delivery failure by identifying abnormal delivery delays between reported events from the carrier, and determining the time between tracking events and total time for delivery of a package. A significant abnormal delay in delivery may be inferred to be due to a delivery address problem, even if the delivery is eventually completed (possibly through manual determination of a more accurate address by the carrier attempting to resolve delivery).

In operation 612, the platform compares the delivery address used in the failed delivery with other delivery addresses used for the same location. In some cases, the delivery address may correspond exactly with the location address. In some cases, the delivery address may include data in addition to the location address. As an example, the delivery address may be the municipal address of a multi-unit building but lacking a unit or suite number, in which case the location of the multi-unit building and the delivery address and location address match. As another example, the delivery address may be a municipal address of a multi-unit building including a unit number, but the location address is the address of the multi-unit building alone. In that case the delivery address includes some data (e.g. the unit number) in addition to the location address.

The platform may have stored in memory historic delivery data associated with the location; in other words, the delivery address data used in previous deliveries to that location. This historic delivery data may be stored in the address database in some implementations. In some cases, the historic data may be stored in a separate delivery database. Using the delivery address, the platform identifies the location and retrieves previously-used delivery address information associated with the location.

The previously-used delivery address information includes an indication of success or failure of that delivery. That is, each delivery address stored in memory may indicate whether the delivery to that delivery address was successful or not. In some cases, the success may be indeterminate if a delivery notification has not been received with regard to that delivery.

Using the previous delivery address information and its associated success or failure, the platform may compare the current delivery address with the previous delivery addresses to determine a probability that missing address information caused the current failure, as indicated by operation 614. This calculation may take into account the reasons for failure if any were determined in operations 606 and 608. The calculation may include comparing prior failed delivery addresses to the current address to identify points of correlation, such as assessing whether they contain the same address information or are missing the same address information. Likewise, the comparison may take into account the delivery addresses associated with successful deliveries to identify whether there is a correlation between inclusion of some additional address information and successful delivery. In some multi-occupant cases, such as with multi-family residential buildings or multi-tenant commercial buildings past delivery events may include successful or unsuccessful deliveries to other recipients at the same location. The past delivery events may be relied upon to determine the probable cause of a failed delivery and, if a sufficient confidence score is determined, the missing supplemental address information that likely resulted in the unsuccessful delivery. In determining the probability, past delivery events may be weighted based on age. That is, the older the event is, the less weight it is given since changes may have occurred in addressing or in the location that make prior delivery data less reliable.

The resulting probability may indicate the likelihood that a particular type or class of additional information is correlated to successful delivery or, conversely, the probability that its absence is correlated to failed delivery. In operation 616, that probability may be compared to a threshold value and if sufficiently probable, i.e. the probability exceeds the threshold value, then in operation 618 the platform may update the address database to indicate that the location is associated with supplemental address information. On this basis, the address database may be updated from time-to-time to flag or signal that certain locations benefit from inclusion of additional address information. The type or category or class of additional address information may also be stored in the address database in association with the location address entry.

The platform may continue to determine probability using the method 600 or variation thereof in connection with failed deliveries, including for addresses already associated with supplemental address information. For instance, the platform may, as a result of subsequent failed deliveries to the location, determine that the probability of supplemental address information being correlated to successful delivery is no longer above the threshold and, on that basis, may update the database to remove the association between the location and supplemental address information. That is, the initial assessment that the location requires supplemental address information may be corrected if subsequent failed deliveries call into question whether the supplemental address information aids in deliverability.

In some cases operation 616 may include comparing the probability to more than one threshold. A lower threshold, e.g. 90%, may be sufficient to indicate in the database that the addresses corresponding to the location should include certain additional address information. A higher threshold, e.g. 98 or 99%, may result in updating the database address entry to indicate that such additional address information is required to complete an address for that location.

In any of the above-described example methods or processes it will be understood that certain operations described as occurring in sequence may be implemented in a different sequence or carried out in parallel without impacting the overall functioning of the method or process.

### Example E-commerce Platform

Although integration with a commerce platform is not required, in some embodiments, the methods disclosed herein may be performed on or in association with a commerce platform such as an e-commerce platform. Therefore, an example of a commerce platform will be described.

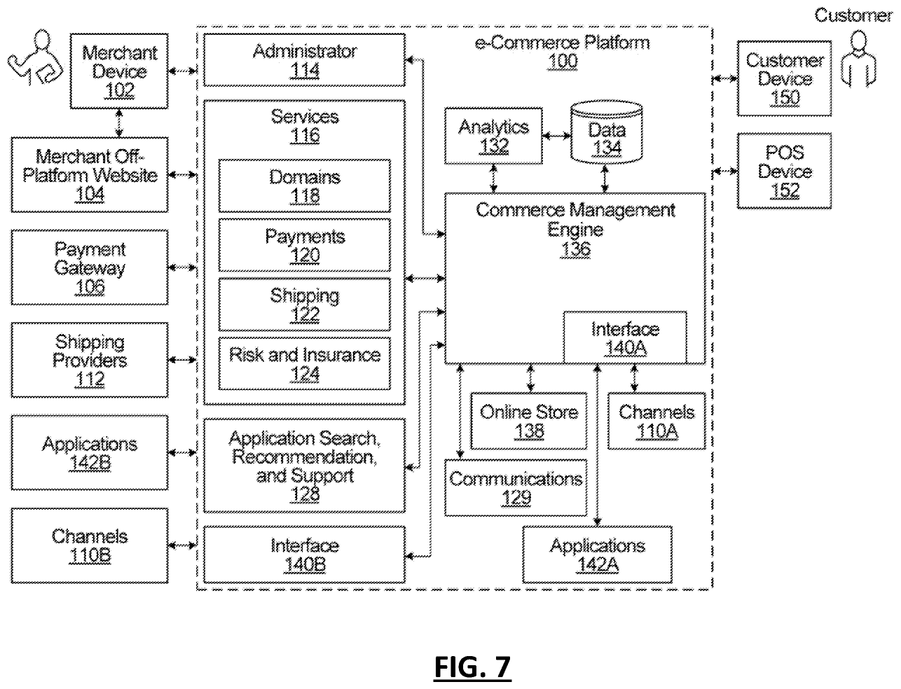

FIG. 7 illustrates an example e-commerce platform 100, according to one embodiment. The e-commerce platform 100 may be exemplary of the e-commerce platform 105 described with reference to FIG. 2. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including, for example, physical products, digital content (e.g., music, videos, games), software, tickets, subscriptions, services to be provided, and the like.

While the disclosure throughout contemplates that a “merchant” and a “customer” may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to “merchants” and “customers”, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, consumer, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like. Furthermore, it may be recognized that while a given user may act in a given role (e.g., as a merchant) and their associated device may be referred to accordingly (e.g., as a merchant device) in one context, that same individual may act in a different role in another context (e.g., as a customer) and that same or another associated device may be referred to accordingly (e.g., as a customer device). For example, an individual may be a merchant for one type of product (e.g., shoes), and a customer/consumer of other types of products (e.g., groceries). In another example, an individual may be both a consumer and a merchant of the same type of product. In a particular example, a merchant that trades in a particular category of goods may act as a customer for that same category of goods when they order from a wholesaler (the wholesaler acting as merchant).

The e-commerce platform 100 provides merchants with online services/facilities to manage their business. The facilities described herein are shown implemented as part of the platform 100 but could also be configured separately from the platform 100, in whole or in part, as stand-alone services. Furthermore, such facilities may, in some embodiments, may, additionally or alternatively, be provided by one or more providers/entities.

In the example of FIG. 7, the facilities are deployed through a machine, service or engine that executes computer software, modules, program codes, and/or instructions on one or more processors which, as noted above, may be part of or external to the platform 100. Merchants may utilize the e-commerce platform 100 for enabling or managing commerce with customers, such as by implementing an e-commerce experience with customers through an online store 138, applications 142A-B, channels 110A-B, and/or through point-of-sale (POS) devices 152 in physical locations (e.g., a physical storefront or other location such as through a kiosk, terminal, reader, printer, 3D printer, and the like). The example computing device 200 of FIG. 1 may be exemplary of each POS device 152. In particular, the POS devices 152 associated with the e-commerce platform 100 may be configured to implement any one or more of the example methods 300 to 600 described above with reference to FIGS. 3 to 6.

A merchant may utilize the e-commerce platform 100 as a sole commerce presence with customers, or in conjunction with other merchant commerce facilities, such as through a physical store (e.g., “brick-and-mortar” retail stores), a merchant off-platform website 104 (e.g., a commerce Internet website or other internet or web property or asset supported by or on behalf of the merchant separately from the e-commerce platform 100), an application 142B, and the like. However, even these “other” merchant commerce facilities may be incorporated into or communicate with the e-commerce platform 100, such as where POS devices 152 in a physical store of a merchant are linked into the e-commerce platform 100, where a merchant off-platform website 104 is tied into the e-commerce platform 100, such as, for example, through “buy buttons” that link content from the merchant off platform website 104 to the online store 138, or the like.

The online store 138 may represent a multi-tenant facility comprising a plurality of virtual storefronts. In embodiments, merchants may configure and/or manage one or more storefronts in the online store 138, such as, for example, through a merchant device 102 (e.g., computer, laptop computer, mobile computing device, and the like), and offer products to customers through a number of different channels 110A-B (e.g., an online store 138; an application 142A-B; a physical storefront through a POS device 152; an electronic marketplace, such, for example, through an electronic buy button integrated into a website or social media channel such as on a social network, social media page, social media messaging system; and/or the like). A merchant may sell across channels 110A-B and then manage their sales through the e-commerce platform 100, where channels 110A may be provided as a facility or service internal or external to the e-commerce platform 100. A merchant may, additionally or alternatively, sell in their physical retail store, at pop ups, through wholesale, over the phone, and the like, and then manage their sales through the e-commerce platform 100. A merchant may employ all or any combination of these operational modalities. Notably, it may be that by employing a variety of and/or a particular combination of modalities, a merchant may improve the probability and/or volume of sales. Throughout this disclosure the terms online store 138 and storefront may be used synonymously to refer to a merchant's online e-commerce service offering through the e-commerce platform 100, where an online store 138 may refer either to a collection of storefronts supported by the e-commerce platform 100 (e.g., for one or a plurality of merchants) or to an individual merchant's storefront (e.g., a merchant's online store).

In some embodiments, a customer may interact with the platform 100 through a customer device 150 (e.g., computer, laptop computer, mobile computing device, or the like), a POS device 152 (e.g., retail device, kiosk, automated (self-service) checkout system, or the like), and/or any other commerce interface device known in the art. The e-commerce platform 100 may enable merchants to reach customers through the online store 138, through applications 142A-B, through POS devices 152 in physical locations (e.g., a merchant's storefront or elsewhere), to communicate with customers via electronic communication facility 129, and/or the like so as to provide a system for reaching customers and facilitating merchant services for the real or virtual pathways available for reaching and interacting with customers.

In some embodiments, and as described further herein, the e-commerce platform 100 may be implemented through a processing facility. Such a processing facility may include a processor and a memory. The processor may be a hardware processor. The memory may be and/or may include a non-transitory computer-readable medium. The memory may be and/or may include random access memory (RAM) and/or persisted storage (e.g., magnetic storage). The processing facility may store a set of instructions (e.g., in the memory) that, when executed, cause the e-commerce platform 100 to perform the e-commerce and support functions as described herein. The processing facility may be or may be a part of one or more of a server, client, network infrastructure, mobile computing platform, cloud computing platform, stationary computing platform, and/or some other computing platform, and may provide electronic connectivity and communications between and amongst the components of the e-commerce platform 100, merchant devices 102, payment gateways 106, applications 142A-B, channels 110A-B, shipping providers 112, customer devices 150, point-of-sale devices 152, etc. In some implementations, the processing facility may be or may include one or more such computing devices acting in concert. For example, it may be that a plurality of co-operating computing devices serves as/to provide the processing facility. The e-commerce platform 100 may be implemented as or using one or more of a cloud computing service, software as a service (SaaS), infrastructure as a service (IaaS), platform as a service (PaaS), desktop as a service (DaaS), managed software as a service (MSaaS), mobile backend as a service (MBaaS), information technology management as a service (ITMaaS), and/or the like. For example, it may be that the underlying software implementing the facilities described herein (e.g., the online store 138) is provided as a service, and is centrally hosted (e.g., and then accessed by users via a web browser or other application, and/or through customer devices 150, POS devices 152, and/or the like). In some embodiments, elements of the e-commerce platform 100 may be implemented to operate and/or integrate with various other platforms and operating systems.

In some embodiments, the facilities of the e-commerce platform 100 (e.g., the online store 138) may serve content to a customer device 150 (using data 134) such as, for example, through a network connected to the e-commerce platform 100. For example, the online store 138 may serve or send content in response to requests for data 134 from the customer device 150, where a browser (or other application) connects to the online store 138 through a network using a network communication protocol (e.g., an internet protocol). The content may be written in machine readable language and may include Hypertext Markup Language (HTML), template language, JavaScript, and the like, and/or any combination thereof.

In some embodiments, online store 138 may be or may include service instances that serve content to customer devices and allow customers to browse and purchase the various products available (e.g., add them to a cart, purchase through a buy-button, and the like). Merchants may also customize the look and feel of their website through a theme system, such as, for example, a theme system where merchants can select and change the look and feel of their online store 138 by changing their theme while having the same underlying product and business data shown within the online store's product information. It may be that themes can be further customized through a theme editor, a design interface that enables users to customize their website's design with flexibility. Additionally, or alternatively, it may be that themes can, additionally or alternatively, be customized using theme-specific settings such as, for example, settings as may change aspects of a given theme, such as, for example, specific colors, fonts, and pre-built layout schemes. In some implementations, the online store may implement a content management system for website content. Merchants may employ such a content management system in authoring blog posts or static pages and publish them to their online store 138, such as through blogs, articles, landing pages, and the like, as well as configure navigation menus. Merchants may upload images (e.g., for products), video, content, data, and the like to the e-commerce platform 100, such as for storage by the system (e.g., as data 134). In some embodiments, the e-commerce platform 100 may provide functions for manipulating such images and content such as, for example, functions for resizing images, associating an image with a product, adding and associating text with an image, adding an image for a new product variant, protecting images, and the like.

As described herein, the e-commerce platform 100 may provide merchants with sales and marketing services for products through a number of different channels 110A-B, including, for example, the online store 138, applications 142A-B, as well as through physical POS devices 152 as described herein. The e-commerce platform 100 may, additionally or alternatively, include business support services 116, an administrator 114, a warehouse management system, and the like associated with running an on-line business, such as, for example, one or more of providing a domain registration service 118 associated with their online store, payment facility 120 for facilitating transactions with a customer, shipping services 122 for providing customer shipping options for purchased products, fulfillment services for managing inventory, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may be configured with shipping services 122 (e.g., through an e-commerce platform shipping facility or through a third-party shipping carrier), to provide various shipping-related information to merchants and/or their customers such as, for example, shipping label or rate information, real-time delivery updates, tracking, and/or the like.

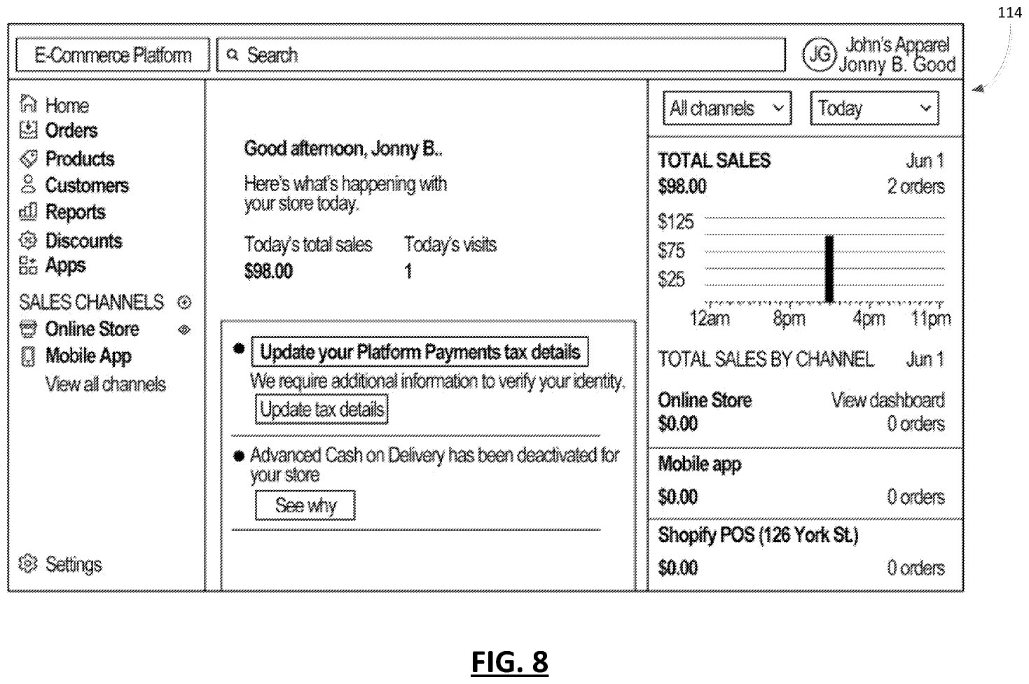

FIG. 8 depicts a non-limiting embodiment for a home page of an administrator 114. The administrator 114 may be referred to as an administrative console and/or an administrator console. The administrator 114 may show information about daily tasks, a store's recent activity, and the next steps a merchant can take to build their business. In some embodiments, a merchant may log in to the administrator 114 via a merchant device 102 (e.g., a desktop computer or mobile device), and manage aspects of their online store 138, such as, for example, viewing the online store's 138 recent visit or order activity, updating the online store's 138 catalog, managing orders, and/or the like. In some embodiments, the merchant may be able to access the different sections of the administrator 114 by using a sidebar, such as the one shown on FIG. 8. Sections of the administrator 114 may include various interfaces for accessing and managing core aspects of a merchant's business, including orders, products, customers, available reports and discounts. The administrator 114 may, additionally or alternatively, include interfaces for managing sales channels for a store including the online store 138, mobile application(s) made available to customers for accessing the store (Mobile App), POS devices, and/or a buy button. The administrator 114 may, additionally or alternatively, include interfaces for managing applications (apps) installed on the merchant's account; and settings applied to a merchant's online store 138 and account. A merchant may use a search bar to find products, pages, or other information in their store.

More detailed information about commerce and visitors to a merchant's online store 138 may be viewed through reports or metrics. Reports may include, for example, acquisition reports, behavior reports, customer reports, finance reports, marketing reports, sales reports, product reports, and custom reports. The merchant may be able to view sales data for different channels 110A-B from different periods of time (e.g., days, weeks, months, and the like), such as by using drop-down menus. An overview dashboard may also be provided for a merchant who wants a more detailed view of the store's sales and engagement data. An activity feed in the home metrics section may be provided to illustrate an overview of the activity on the merchant's account. For example, by clicking on a “view all recent activity” dashboard button, the merchant may be able to see a longer feed of recent activity on their account. A home page may show notifications about the merchant's online store 138, such as based on account status, growth, recent customer activity, order updates, and the like. Notifications may be provided to assist a merchant with navigating through workflows configured for the online store 138, such as, for example, a payment workflow, an order fulfillment workflow, an order archiving workflow, a return workflow, and the like.

The e-commerce platform 100 may provide for a communications facility 129 and associated merchant interface for providing electronic communications and marketing, such as utilizing an electronic messaging facility for collecting and analyzing communication interactions between merchants, customers, merchant devices 102, customer devices 150, POS devices 152, and the like, to aggregate and analyze the communications, such as for increasing sale conversions, and the like. For instance, a customer may have a question related to a product, which may produce a dialog between the customer and the merchant (or an automated processor-based agent/chatbot representing the merchant), where the communications facility 129 is configured to provide automated responses to customer requests and/or provide recommendations to the merchant on how to respond such as, for example, to improve the probability of a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between the e-commerce platform 100 and a merchant's bank account, and the like. The financial facility 120 may also provide merchants and buyers with financial support, such as through the lending of capital (e.g., lending funds, cash advances, and the like) and provision of insurance. In some embodiments, online store 138 may support a number of independently administered storefronts and process a large volume of transactional data on a daily basis for a variety of products and services. Transactional data may include any customer information indicative of a customer, a customer account or transactions carried out by a customer such as. for example, contact information, billing information, shipping information, returns/refund information, discount/offer information, payment information, or online store events or information such as page views, product search information (search keywords, click-through events), product reviews, abandoned carts, and/or other transactional information associated with business through the e-commerce platform 100. In some embodiments, the e-commerce platform 100 may store this data in a data facility 134. Referring again to FIG. 7, in some embodiments the e-commerce platform 100 may include a commerce management engine 136 such as may be configured to perform various workflows for task automation or content management related to products, inventory, customers, orders, suppliers, reports, financials, risk and fraud, and the like. In some embodiments, additional functionality may, additionally or alternatively, be provided through applications 142A-B to enable greater flexibility and customization required for accommodating an ever-growing variety of online stores, POS devices, products, and/or services. Applications 142A may be components of the e-commerce platform 100 whereas applications 142B may be provided or hosted as a third-party service external to e-commerce platform 100. The commerce management engine 136 may accommodate store-specific workflows and in some embodiments, may incorporate the administrator 114 and/or the online store 138.

Implementing functions as applications 142A-B may enable the commerce management engine 136 to remain responsive and reduce or avoid service degradation or more serious infrastructure failures, and the like.

Although isolating online store data can be important to maintaining data privacy between online stores 138 and merchants, there may be reasons for collecting and using cross-store data, such as, for example, with an order risk assessment system or a platform payment facility, both of which require information from multiple online stores 138 to perform well. In some embodiments, it may be preferable to move these components out of the commerce management engine 136 and into their own infrastructure within the e-commerce platform 100.

Platform payment facility 120 is an example of a component that utilizes data from the commerce management engine 136 but is implemented as a separate component or service. The platform payment facility 120 may allow customers interacting with online stores 138 to have their payment information stored safely by the commerce management engine 136 such that they only have to enter it once. When a customer visits a different online store 138, even if they have never been there before, the platform payment facility 120 may recall their information to enable a more rapid and/or potentially less-error prone (e.g., through avoidance of possible mis-keying of their information if they needed to instead re-enter it) checkout. This may provide a cross-platform network effect, where the e-commerce platform 100 becomes more useful to its merchants and buyers as more merchants and buyers join, such as because there are more customers who checkout more often because of the ease of use with respect to customer purchases. To maximize the effect of this network, payment information for a given customer may be retrievable and made available globally across multiple online stores 138.

For functions that are not included within the commerce management engine 136, applications 142A-B provide a way to add features to the e-commerce platform 100 or individual online stores 138. For example, applications 142A-B may be able to access and modify data on a merchant's online store 138, perform tasks through the administrator 114, implement new flows for a merchant through a user interface (e.g., that is surfaced through extensions/API), and the like. Merchants may be enabled to discover and install applications 142A-B through application search, recommendations, and support 128. In some embodiments, the commerce management engine 136, applications 142A-B, and the administrator 114 may be developed to work together. For instance, application extension points may be built inside the commerce management engine 136, accessed by applications 142A and 142B through the interfaces 140B and 140A to deliver additional functionality, and surfaced to the merchant in the user interface of the administrator 114.

In some embodiments, applications 142A-B may deliver functionality to a merchant through the interface 140A-B, such as where an application 142A-B is able to surface transaction data to a merchant (e.g., App: “Engine, surface my app data in the Mobile App or administrator 114”), and/or where the commerce management engine 136 is able to ask the application to perform work on demand (Engine: “App, give me a local tax calculation for this checkout”).

Applications 142A-B may be connected to the commerce management engine 136 through an interface 140A-B (e.g., through REST (REpresentational State Transfer) and/or GraphQL APIs) to expose the functionality and/or data available through and within the commerce management engine 136 to the functionality of applications. For instance, the e-commerce platform 100 may provide API interfaces 140A-B to applications 142A-B which may connect to products and services external to the platform 100. The flexibility offered through use of applications and APIs (e.g., as offered for application development) enable the e-commerce platform 100 to better accommodate new and unique needs of merchants or to address specific use cases without requiring constant change to the commerce management engine 136. For instance, shipping services 122 may be integrated with the commerce management engine 136 through a shipping or carrier service API, thus enabling the e-commerce platform 100 to provide shipping service functionality without directly impacting code running in the commerce management engine 136.

Depending on the implementation, applications 142A-B may utilize APIs to pull data on demand (e.g., customer creation events, product change events, or order cancelation events, etc.) or have the data pushed when updates occur. A subscription model may be used to provide applications 142A-B with events as they occur or to provide updates with respect to a changed state of the commerce management engine 136. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time or near-real time.

In some embodiments, the e-commerce platform 100 may provide one or more of application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, and the like. In some embodiments, applications 142A-B may be assigned an application identifier (ID), such as for linking to an application (e.g., through an API), searching for an application, making application recommendations, and the like.

Applications 142A-B may be grouped roughly into three categories: customer-facing applications, merchant-facing applications, integration applications, and the like. Customer-facing applications 142A-B may include an online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways 106.

As such, the e-commerce platform 100 can be configured to provide an online shopping experience through a flexible system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products through a number of different channels 110A-B such as, for example, the merchant's online store 138, a physical storefront through a POS device 152; an electronic marketplace, through an electronic buy button integrated into a website or a social media channel). In some cases, channels 110A-B may be modeled as applications 142A-B. A merchandising component in the commerce management engine 136 may be configured for creating, and managing product listings (using product data objects or models for example) to allow merchants to describe what they want to sell and where they sell it. The association between a product listing and a channel may be modeled as a product publication and accessed by channel applications, such as via a product listing API. A product may have many attributes and/or characteristics, like size and color, and many variants that expand the available options into specific combinations of all the attributes, like a variant that is size extra-small and green, or a variant that is size large and blue. Products may have at least one variant (e.g., a “default variant”) created for a product without any options. To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Product listings may include 2D images, 3D images or models, which may be viewed through a virtual or augmented reality interface, and the like.

In some embodiments, a shopping cart object is used to store or keep track of the products that the customer intends to buy. The shopping cart object may be channel specific and can be composed of multiple cart line items, where each cart line item tracks the quantity for a particular product variant. Since adding a product to a cart does not imply any commitment from the customer or the merchant, and the expected lifespan of a cart may be in the order of minutes (not days), cart objects/data representing a cart may be persisted to an ephemeral data store.

The customer then proceeds to checkout. A checkout object or page generated by the commerce management engine 136 may be configured to receive customer information to complete the order such as the customer's contact information, billing information and/or shipping details. If the customer inputs their contact information but does not proceed to payment, the e-commerce platform 100 may (e.g., via an abandoned checkout component) transmit a message to the customer device 150 to encourage the customer to complete the checkout. For those reasons, checkout objects can have much longer lifespans than cart objects (hours or even days) and may therefore be persisted. Customers then pay for the content of their cart resulting in the creation of an order for the merchant. In some embodiments, the commerce management engine 136 may be configured to communicate with various payment gateways and services 106 (e.g., online payment systems, mobile payment systems, digital wallets, credit card gateways) via a payment processing component. The actual interactions with the payment gateways 106 may be provided through a card server environment. At the end of the checkout process, an order is created. An order is a contract of sale between the merchant and the customer where the merchant agrees to provide the goods and services listed on the order (e.g., order line items, shipping line items, and the like) and the customer agrees to provide payment (including taxes). Once an order is created, an order confirmation notification may be sent to the customer and an order placed notification sent to the merchant via a notification component. Inventory may be reserved when a payment processing job starts to avoid over-selling (e.g., merchants may control this behavior using an inventory policy or configuration for each variant). Inventory reservation may have a short time span (minutes) and may need to be fast and scalable to support flash sales or “drops”, which are events during which a discount, promotion or limited inventory of a product may be offered for sale for buyers in a particular location and/or for a particular (usually short) time. The reservation is released if the payment fails. When the payment succeeds, and an order is created, the reservation is converted into a permanent (long-term) inventory commitment allocated to a specific location. An inventory component of the commerce management engine 136 may record where variants are stocked, and may track quantities for variants that have inventory tracking enabled. It may decouple product variants (a customer-facing concept representing the template of a product listing) from inventory items (a merchant-facing concept that represents an item whose quantity and location is managed). An inventory level component may keep track of quantities that are available for sale, committed to an order or incoming from an inventory transfer component (e.g., from a vendor).

The merchant may then review and fulfill (or cancel) the order. A review component of the commerce management engine 136 may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) before it marks the order as paid. The merchant may now prepare the products for delivery. In some embodiments, this business process may be implemented by a fulfillment component of the commerce management engine 136. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. Alternatively, an API fulfillment service may trigger a third-party application or service to create a fulfillment record for a third-party fulfillment service. Other possibilities exist for fulfilling an order. If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

### Implementations

The methods and systems described herein may be deployed in part or in whole through a machine that executes computer software, program codes, and/or instructions on a processor. The processor may be part of a server, cloud server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In some embodiments, the process may be a dual core processor, quad core processors, other chip-level multiprocessor and the like that combine two or more independent cores (called a die).

The methods and systems described herein may be deployed in part or in whole through a machine that executes computer software on a server, cloud server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented in different devices which may operate in wired or wireless networks. Examples of wireless networks include 4th Generation (4G) networks (e.g., Long-Term Evolution (LTE)) or 5th Generation (5G) networks, as well as non-cellular networks such as Wireless Local Area Networks (WLANs). However, the principles described therein may equally apply to other types of networks.

The operations, methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another, such as from usage data to a normalized usage dataset.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above, and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

1. A computer-implemented method of obtaining address data and generating deliverable address data, comprising:
receiving address data input via one or more address fields in a graphical user interface;
searching a database of address entries, using the address data, to identify a location having an entry in the database that matches the address data;
determining from the entry in the database that the location is associated with supplemental address information;
responsive to the determining from the entry in the database that the location is associated with the supplemental address information, causing generation of a modified graphical user interface that displays a supplemental address field that was not displayed in the graphical user interface;
receiving additional address information via the supplemental address field; and
outputting a complete deliverable address containing at least the address data and the additional address information.

2. The method of claim 1, wherein determining includes determining, from the database, that the location is associated with a deliverable address schema, and wherein the deliverable address schema includes the supplemental address information.

3. The method of claim 1, wherein searching includes matching at least a portion of the address data to one or more address entries and, based on the address entries, identifying the location.

4. The method of claim 1, wherein the location is a multi-unit building, and wherein the supplemental address information includes one or more of a unit number, a mailbox number, a buzzer code, a door code, a locker number, building name, or a floor number.

5. The method of claim 1, wherein the location is a municipal area that includes multiple buildings, and wherein the supplemental address information includes one or more of directional text, descriptive text, or a map pinpoint.

6. The method of claim 1, further comprising first:
receiving a plurality of delivery notifications from one or more carriers with regard to deliveries to the location; and
updating the database to associate the location with the supplemental address information based on the plurality of delivery notification.

7. The method of claim 6, wherein the plurality of delivery notifications include one or more failure notifications and one or more success notifications with regard to deliveries to the location.

8. The method of claim 7, further comprising comparing address information associated with success notifications to address information associated with failure notifications to generate a deliverable address format requirement for the location, wherein the deliverable address format includes the supplemental address information, and updating the database to associate the location with the deliverable address format requirement.

9. The method of claim 1, further comprising first:
receiving one or more delivery failure notifications relating to the location; and
updating the database based on the delivery failure notifications to associate the location with the supplemental address information.

10. The method of claim 9, further comprising, in response to the one or more delivery failure notifications, transmitting a delivery failure inquiry to one or more accounts associated with the one or more delivery failure notifications and, in response, receiving feedback data that specifies the supplemental address information.

11. The method of claim 1, wherein causing generation of the modified graphical user interface includes sending data to a user device, wherein the user device generates and displays the modified graphical user interface based on the data.

12. The method of claim 1, wherein causing generation of the modified graphical user interface includes sending data to a user device, wherein the user device uses the data to modify the graphical user interface displayed on the user device to produce the modified graphical user interface.

13. A computing device, comprising:
a processor;
a database of address entries; and
a memory coupled to the processor, the memory storing instructions that, when executed by the processor, are to cause the processor to:
receive address data input via one or more address fields in a graphical user interface;
search the database of address entries, using the address data, to identify a location having an entry in the database that matches the address data;
determine from the entry in the database that the location is associated with supplemental address information;
responsive to the determination from the entry in the database that the location is associated with the supplemental address information, cause generation of a modified graphical user interface that displays a supplemental address field that was not displayed in the graphical user interface;
receive additional address information via the supplemental address field; and
output a complete deliverable address containing at least the address data and the additional address information.

14. The computing device of claim 13, wherein the instructions, when executed, are to cause the processor to determine by determining, from the database, that the location is associated with a deliverable address schema, and wherein the deliverable address schema includes the supplemental address information.

15. The computing device of claim 13, wherein the instructions, when executed, are to cause the processor to search by matching at least a portion of the address data to one or more address entries and, based on the address entries, identifying the location.

16. The computing device of claim 13, wherein the supplemental address information includes one or more of a unit number, a mailbox number, a buzzer code, a door code, a locker number, building name, a floor number, directional text, descriptive text, or a map pinpoint.

17. The computing device of claim 13, wherein the instructions, when executed, further cause the processor to:
receive a plurality of delivery notifications from one or more carriers with regard to deliveries to the location; and
update the database to associate the location with the supplemental address information based on the plurality of delivery notifications.

18. The computing device of claim 17, wherein the plurality of delivery notifications include one or more failure notifications and one or more success notifications with regard to deliveries to the location.

19. The computing device of claim 18, wherein the instructions, when executed, further cause the processor to compare address information associated with success notifications to address information associated with failure notifications to generate a deliverable address format requirement for the location, wherein the deliverable address format includes the supplemental address information, and to update the database to associate the location with the deliverable address format requirement.

20. The computing device of claim 13, wherein the instructions, when executed, first further cause the processor to:
receive one or more delivery failure notifications relating to the location; and
update the database based on the delivery failure notifications to associate the location with the supplemental address information.

21. The computing device of claim 20, wherein the instructions, when executed, further cause the processor to, in response to the one or more delivery failure notifications, transmit a delivery failure inquiry to one or more accounts associated with the one or more delivery failure notifications and, in response, receive feedback data that specifies the supplemental address information.

22. The computing device of claim 13, wherein the instructions, when executed, are to cause generation of the modified graphical user interface by sending data to a user device, wherein the user device generates and displays the modified graphical user interface based on the data.

23. The computing device of claim 13, wherein the instructions, when executed, are to cause generation of the modified graphical user interface by sending data to a user device, wherein the user device uses the data to modify the graphical user interface displayed on the user device to produce the modified graphical user interface.

24. A non-transitory, computer-readable medium storing computer-executable instructions that, when executed by a processor, are to cause the processor to:
receive address data input via one or more address fields in a graphical user interface;
search a database of address entries, using the address data, to identify a location having an entry in the database that matches the address data;
determine from the entry in the database that the location is associated with supplemental address information;
responsive to the determination from the entry in the database that the location is associated with the supplemental address information, cause generation of a modified graphical user interface that displays a supplemental address field that was not displayed in the graphical user interface;
receive additional address information via the supplemental address field; and
output a complete deliverable address containing at least the address data and the additional address information.
